(19) United States
(12) Patent Application Publication
(10) Pub. No.: US 2007/0214365 A1
(43) Pub. Date: Sep. 13, 2007

(54) Document repository

(76) Inventors: John D. Cornett, Houston, TX (US); William F. Guest, Houston, TX (US)

Correspondence Address: Stephen S. Hodgson, 2636 Albans Rd., Houston, TX, 77005, US

(21) Appl. No.: 11/714,929

(22) Filed: Mar. 7, 2007

Related U.S. Application Data
(60) Provisional application No. 60/781,913, filed on Mar. 13, 2006.

(51) Int. Cl. H04L 9/00

(52) U.S. Cl. 713/183

(57) ABSTRACT

A method and system for gathering, storing, and accessing documents used to grant authority for one person to perform on behalf of another person the actions specified in such documents in an independent repository. Such documents are submitted to the repository by one of various means whereby electronic versions of such documents are stored on the repository's system. Using unique identifying codes assigned to such documents, third parties called on to act in reliance on such documents may access such electronic versions and information related thereto to authenticate the documents upon which they are being asked to rely. The method provides an effective means of revoking such documents. The method provides a monitoring mechanism whereby third party access to an electronic document stored on the repository generates a notice to the appropriate persons. Electronic versions of the documents are available at all times, and copies of the documents can be generated and delivered upon request.

### CROSS-REFERENCE TO RELATED APPLICATIONS

Priority is claimed to U.S. Provisional Patent Application Ser. No. 60/781,913, filed by the inventors on Mar. 13, 2006, which is incorporated by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a repository for documents, and more particularly to a computerized repository for electronic documents.

2. Description of the Prior Art

There are a number of documents in common use whereby one person, referred to herein as the “principal,” grants legal authority to one or more other persons, referred to herein as the “agent,” the power and right to perform actions on behalf of the principal. Such documents, referred to herein as “authorizing documents,” include, but are not limited to, financial powers of attorney, medical powers of attorney, living wills, HIPAA authorizations, testamentary wills, and trusts. A financial power of attorney enables an agent designated by the principal to engage in and execute financial transactions of the types stipulated in the financial power of attorney on behalf of the principal. Other terms commonly used to refer to a financial power of attorney include, but are not limited to, “general power of attorney,” “durable power of attorney for finances,” “financial enduring power of attorney,” “financial statutory power of attorney,” and “commercial power of attorney.” A medical power of attorney authorizes an agent to make medical decisions regarding the care of the principal upon the incapacity of the principal. Other terms commonly used to refer to a medical power of attorney include, but are not limited to, “durable power of attorney for health care,” “health care surrogate,” “health care proxy,” and “medical enduring power of attorney.” A living will expresses the principal's directives to medical professionals regarding the use of extraordinary medical measures should the principal be incapacitated and diagnosed with a terminal illness or irreversible condition whereby the principal will not live without such extraordinary medical measures. Other terms commonly used to refer to a living will include, but are not limited to, “advance directive,” “medical directive,” and “directive to physicians.” A HIPAA authorization authorizes a medical professional to release and to discuss with an agent medical information covered by the Health Insurance Portability and Accountability Act of 1996, “HIPAA,” regarding a principal. A testamentary will authorizes an agent, commonly referred to as an “executor,” “executrix,” or “personal representative,” to settle the estate of the principal and follow the instructions contained in the testamentary will upon the death of the principal. Other terms commonly used to refer to a testamentary will include, but are not limited to, “last will and testament” and “will.” A trust enables an agent, commonly referred to as a “trustee,” designated by the principal to engage in and execute financial transactions of the types stipulated in the trust involving assets contained in such trust.

While authorizing documents provide the potential of substantial benefits to the principal, his or her family, and society when properly and effectively utilized, there are a number of risks associated with such authorizing documents. One such risk is that those authorizing documents involving financial transactions may be misused by the agent to the detriment of the principal. This risk is compounded by the prevalent legal view that a principal will be held to transactions executed using a revoked authorizing document unless the principal has provided third parties involved with such transactions with notice of such revocation. Another risk is that third parties will fail to act upon a properly executed authorizing document due to the third parties' concern regarding the authenticity of the authorizing document, whether the authorizing document presented to such third parties is the most current version of such authorizing document, and whether the purported agent presenting an authorizing document is indeed the agent named in the authorizing document. Another risk is that the authorizing document will not be accessible at a time-critical point of need. This is especially true of medical powers of attorney and living wills. Frequently, authorizing documents are stored in safety deposit boxes or attorneys' offices and are therefore not readily accessible in an emergency situation.

U.S. Pat. No. 5,241,466, issued to Perry et al. and incorporated herein by reference for all purposes, attempts to address the risk that an authorizing document will not be available when needed. Perry et al. describe a central depository for storage and retrieval of documents such as living wills, durable powers of attorney, testamentary wills, authorization for organ and bone marrow donation, and insurance information. While the patent issued to Perry et al. describes a useful system for the limited types of authorizing documents addressed therein, a number of problems concerning the use of authorizing documents still exist.

### SUMMARY OF THE INVENTION

The present invention provides a method for reducing or eliminating risks associated with authorizing documents to principals, agents, and third parties who are called on to act in reliance on such authorizing documents. The present invention provides a method for protecting principals by providing the capability of having use of the authorizing documents monitored, by providing an effective means of revocation, and by providing around-the-clock access by authorized persons to the authorizing documents. The present invention provides a method for protecting agents by providing an effective means of resignation. The present invention provides a method for protecting third parties acting in reliance on authorizing documents by providing comfort that the authorizing documents are authentic and current and that such third parties are dealing with an authentic and current agent.

The present invention provides a method and system whereby legally executed authorizing documents are submitted via any one of multiple modes to an independent repository who stores electronic versions of such authorizing documents in the repository's system for later access by authorized persons by any one of multiple modes. The electronic versions of the authorizing documents are available around-the-clock from virtually any geographical location. The constant availability of the electronic versions of the authorizing documents in the repository solves the problem of lack of accessibility to the authorizing documents during a time of need, and in particular during an emergency situation where time is of the essence.

The present invention provides a method whereby third parties called on to act in reliance on authorizing documents may access the electronic versions of the authorizing documents in the repository, receive information regarding any steps the repository took to authenticate the authorizing documents, receive information, as further described below, as to whether the authorizing document is current and whether there have been any changes regarding any agent named in such authorizing documents, and have the ability to compare the electronic version of the authorizing documents stored in the repository to any version of the authorizing documents from a source other than the repository that may have been provided to the third party to initiate the request upon which such third party is being asked to act. Through these features of the present invention third parties called on to act in reliance on authorizing documents gain comfort in the authenticity and status of such authorizing documents, increasing the likelihood that such third parties will perform the requested acts.

The present invention provides a method whereby a principal may access the repository's system and process a revocation transaction with respect to one or more of the principal's authorizing documents stored in the repository. Such revocation transaction preferably generates a notice to the principal, agent, other persons designated in advance by the principal to receive notice of third party access to authorizing documents (referred to herein as “monitors”), and third parties who have in the past accessed such authorizing documents through the repository's system that the corresponding authorizing documents have been revoked. The present invention provides a method whereby persons attempting to access a previously-stored authorizing document that has been revoked will receive a notice contemporaneous to such access attempt that such authorizing document has been revoked. The ability to effectively revoke an authorizing document reduces the risk to the principal that a third party will act upon a revoked authorizing document.

The present invention provides a method whereby an agent may access the repository's system and process a resignation transaction with respect to one or more of the principal's authorizing documents stored in the repository that name such agent. Such resignation transaction preferably generates a notice to the principal, agent, monitors, and third parties who have in the past accessed such authorizing documents through the repository's system that the corresponding agent has resigned with respect to such authorizing documents. The present invention provides a method whereby persons attempting to access a previously-stored authorizing document will receive a notice contemporaneous to such access attempt that the agent has resigned with respect to such authorizing document. The ability to effectively resign as an agent reduces the risk that a third party will act upon the directions of an agent who is no longer active with respect to the authorizing documents.

The present invention provides a method whereby third party access to an authorizing document stored on the repository is tracked by the repository's system and, upon such access, generates a notice to the principal, agent, and monitors providing information regarding such access. In one embodiment of the present invention, principals and their authorized agents may sign on to the repository's system and view a history of accesses made to their corresponding authorizing documents. The monitoring of the use of the authorizing documents, through monitoring of access to the electronic versions of such authorizing documents in the repository, reduces the risk that the authorizing documents will be misused to the detriment of the principal.

The present invention provides a method whereby an agent can establish on the repository's system a unique one-time-use code, referred to herein as a “confirmation code,” that the agent can then provide to third parties being called upon to act in reliance on authorizing documents. Such third parties can then input the confirmation code provided by the agent into the repository's system and receive from such system confirmation as to whether or not the confirmation code provided is valid. Since the confirmation code can only be created using access codes that have been uniquely assigned to the agent, third parties gain comfort through the confirmation code that the agent is who he or she represents to be.

The present invention further provides a repository for documents other than authorizing documents, and the repository can be used by people who are not necessarily a principal on the document being stored. Other features and advantages of the invention will be apparent from the following specification taken in conjunction with the following drawings.

### BRIEF DESCRIPTION OF THE DRAWINGS

FIG. 1 is a flowchart of a method and system for submitting authorizing documents to a repository and converting the documents, if necessary, to an electronic version that is then stored in the repository according to the present invention.

FIG. 2 is a flowchart of a method and system for interacting with third parties who request access to the repository's stored electronic version of an authorizing document and who attempt to verify the identity of an agent through a confirmation code according to the present invention.

FIG. 3 is a flowchart of a method and system for interacting with a member, such as a registered principal, agent, or monitor, according to the present invention.

FIG. 4 is an illustration of components for a system for storing and retrieving authorizing documents, detailing the interaction between the components of the system, according to the present invention.

### DETAILED DESCRIPTION OF THE INVENTION

The present invention is susceptible to embodiment in many different forms. Shown in the drawings and herein described in detail are preferred embodiments with the understanding that the present disclosure is to be considered an exemplification of the principles of the invention and is not intended to limit the scope of the claimed inventive concept to the embodiments illustrated.

The invention relates to storing in an independent repository electronic versions of documents used to grant authority for one person to perform on behalf of another person the actions specified in such documents so that such electronic versions may be later retrieved by authorized personnel with such retrieval monitored as designated by the grantor of such documents. Other types of documents can also be stored in a repository, which can be operated by a person unrelated to the owner of the documents, providing an online filing system for documents, which can be retrieved upon request.

There are a number of documents in common use whereby one person, referred to herein as the “principal,” grants legal authority to one or more other persons, referred to herein as the “agent,” the power and right to perform actions on behalf of the principal. Such documents, referred to herein as “authorizing documents,” include, but are not limited to, financial powers of attorney, medical powers of attorney, living wills, HIPAA authorizations, testamentary wills, and trusts. A financial power of attorney enables an agent designated by the principal to engage in and execute financial transactions of the types stipulated in the financial power of attorney on behalf of the principal. Other terms commonly used to refer to a financial power of attorney include, but are not limited to, “general power of attorney,” “durable power of attorney for finances,” “financial enduring power of attorney,” “financial statutory power of attorney,” and “commercial power of attorney.” A medical power of attorney authorizes an agent to make medical decisions regarding the care of the principal upon the incapacity of the principal. Other terms commonly used to refer to a medical power of attorney include, but are not limited to, “durable power of attorney for health care,” “health care surrogate,” “health care proxy,” and “medical enduring power of attorney.” A living will expresses the principal's directives to medical professionals regarding the use of extraordinary medical measures should the principal be incapacitated and diagnosed with a terminal illness or irreversible condition whereby the principal will not live without such extraordinary medical measures. Other terms commonly used to refer to a living will include, but are not limited to, “advance directive,” “medical directive,” and “directive to physicians.” A HIPAA authorization authorizes a medical professional to release and to discuss with an agent medical information covered by the Health Insurance Portability and Accountability Act of 1996, “HIPAA,” regarding a principal. A testamentary will authorizes an agent, commonly referred to as an “executor,” “executrix,” or “personal representative,” to settle the estate of the principal and follow the instructions contained in the testamentary will upon the death of the principal. Other terms commonly used to refer to a testamentary will include, but are not limited to, “last will and testament” and “will.” A trust enables an agent, commonly referred to as a “trustee,” designated by the principal to engage in and execute financial transactions of the types stipulated in the trust involving assets contained in such trust.

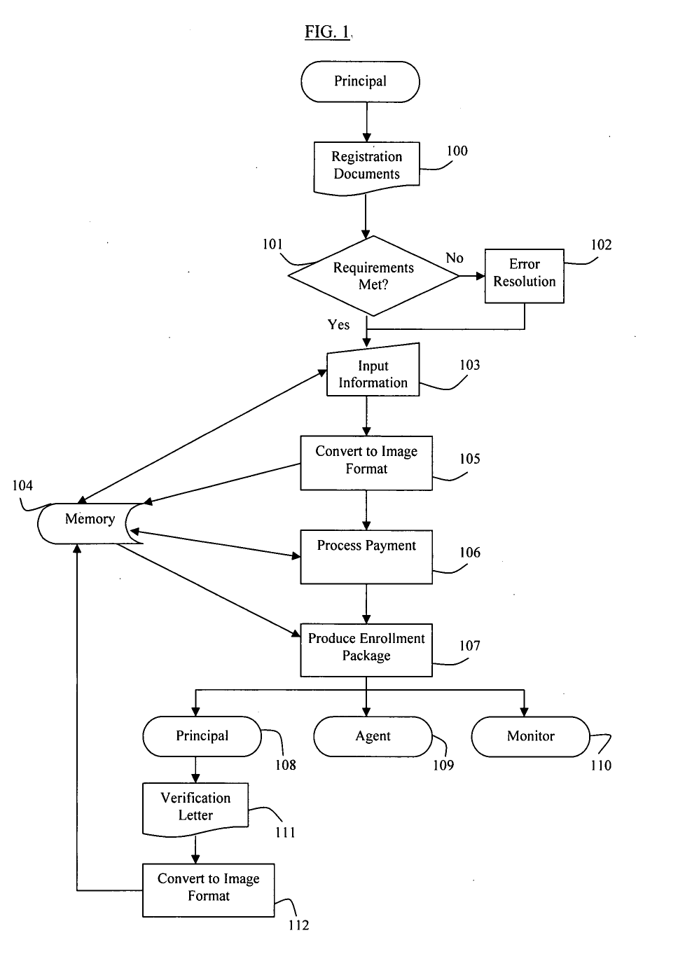

Referring to FIG. 1, in one embodiment of the present invention, a principal submits documents and information to a repository for registration 100. The registration documents include an application for registration containing key information regarding the principal, agent, and monitor. Such key information includes the name, address, telephone number, and email address for each of the principal, agent, and monitor. Additionally, the date of birth of the principal is provided, and optionally, information regarding any medical conditions or allergies and emergency contact information regarding the principal. The registration documents also include the authorizing documents. The various means by which the registration documents may be submitted to the repository include, but are not limited to, mail, electronic means, such as an email transmission, and fax transmission. The repository should screen the registration documents to insure that the requirements for registration have been met 101 and resolve any issues that would prevent registration 102. If the authorizing documents submitted for registration do not incorporate within the body of such authorizing documents language sufficient to alert third parties that the documents have been registered with the repository and that third parties should authenticate the authorizing documents through the repository, each page of the submitted documents will be stamped, either through a physical marking or through an electronic means, as appropriate, with language that accomplishes such alert to third parties. Once cleared for registration, information regarding the principal, agent, and monitor as well as information regarding the authorizing documents will be input 103 to system memory 104 at which point a unique identifying user identification number or code will be assigned to each principal, agent, and monitor. Such input may be accomplished by manual keying of information, electronic capture from the source submissions, or a combination of the two methods. If not submitted in that format, the documents will then be converted to the electronic format used by the repository 105 and stored in such format in memory 104 at which point a unique identifying number will be assigned to each authorizing document. Such conversion may be accomplished by a scanning of paper documents or a software conversion of an electronic submission. The electronic format of the repository may be one of a number of formats suitable for such purposes including, but not limited to, such standard formats as PDF, TIFF, and JPEG.

Continuing to refer to FIG. 1, in one embodiment of the invention, the registrant pays a fee for registration that is processed by the repository 106 with a recording of such payment in memory 104 and validation of the amount of such payment against information contained in memory 104. Upon successful registration, an enrollment package is produced containing information extracted from memory 104. In one embodiment of the invention, such enrollment package includes information to be sent to the principal 108 comprised of information on accessing the repository's system, access codes for such access, the identifying numbers assigned by the repository to the authorizing documents, instructions to be given to third parties on accessing the electronic versions of the authorizing documents in the repository, a verification letter 111, and the return of any paper authorizing documents submitted by the principal to the repository; information to be sent to the agent 109 comprised of information on accessing the repository's system, access codes for such access, the identifying numbers assigned by the repository to the authorizing documents, and instructions to be given to third parties on accessing the electronic versions of the authorizing documents in the repository; and information to be sent to the monitor describing the possible notices the monitor may receive in the future upon a third party's access to the electronic versions of the authorizing documents stored at the repository. The verification letter 111 sent to the principal asks the principal to review the electronic versions of the authorizing documents stored in memory 104 of the repository, confirm that such electronic versions are complete and accurate, and return the verification letter with such confirmation to the repository. Upon receipt of the verification letter 111 from the principal, the verification letter will be loaded into memory 112 and available to third parties accessing the associated authorizing documents.

In a preferred embodiment of the present invention, the identifying numbers assigned by the repository to the authorizing documents are provided to the principal on a card that also contains the optional emergency medical profile information submitted by the principal. The card further contains information concerning how to contact the document repository. In one embodiment of the present invention, amendments to previously-registered authorizing documents are handled by revoking the previously-registered document and processing the amended document as a new registration. In another embodiment of the present invention, amendments to previously-registered authorizing documents are handled by appending any amendments to the electronic versions of the authorizing documents already stored in the repository.

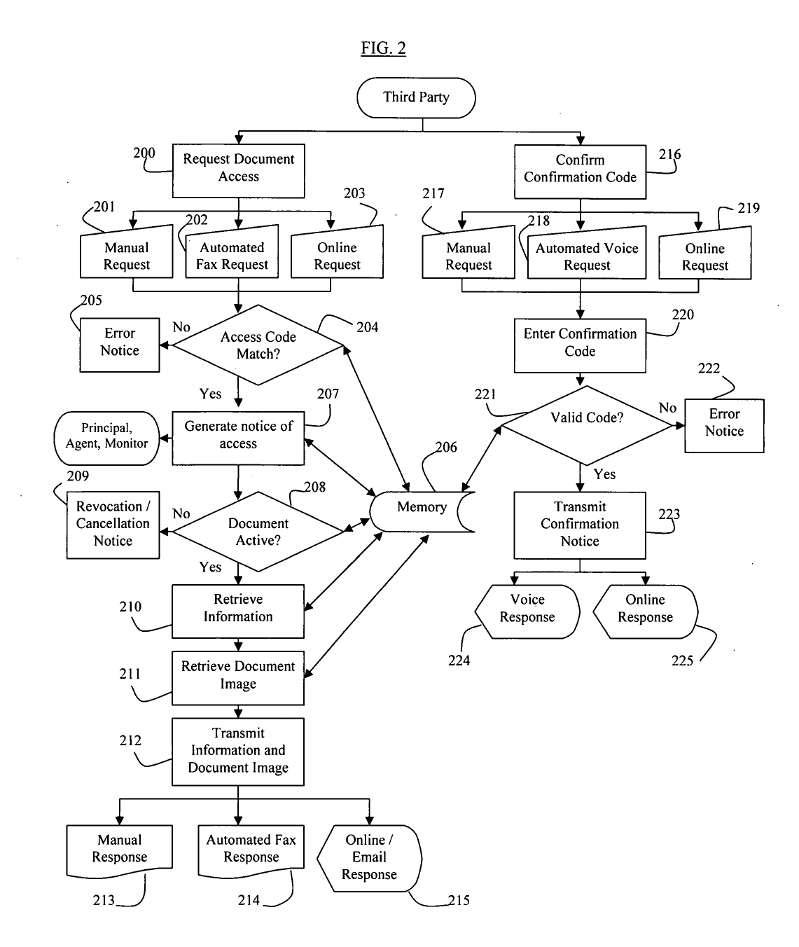

Referring to FIG. 2, third parties called upon to act in reliance on authorizing documents that have been registered with the repository may access the repository's system to request document access 200 for purposes of authenticating the authorizing documents or to confirm a confirmation code 216 given to such third parties by an agent for purposes of authenticating the identity of such agent. The third party may request document access 200 by telephonic communication with an employee of the repository 201, through telephonic communication with an interactive voice response system designed to result in an automatic fax transmission to the third party 202, or through online access to the repository's system 203. Whichever means of initiation, the third party preferably provides contact information regarding the third party, which information will be stored to memory 206, and an access code associated with the authorizing document for which access is being requested. The access code given by the third party will be compared 204 to the access code contained in memory 206. If the access codes do not match, an error notification will be given to the requesting third party 205. If the access codes do match, a notice of access by the third party will be automatically generated to the principal, agent, and monitor 207. Such notice will contain information extracted from memory 206 of the date and time of the third party access and the contact information provided by the third party. Memory 206 will be checked to see whether the requested authorizing document has been revoked or if the principal's membership with the repository has been cancelled 208. If the authorizing document has been revoked or the principal's membership cancelled, the requesting third party will be so notified 209. Otherwise, information regarding the authorizing document will be retrieved 210 from memory 206.

In a preferred embodiment of the invention, such information includes disclosure of the form of the authorizing document that was submitted to the repository, i.e., a notarized original, an unnotarized original, a photocopy, or an electronic version. Such information also includes disclosure as to whether the principal sent a letter to the repository acknowledging that the principal reviewed the electronic version of the associated authorizing document on the repository and found that such electronic version was complete and accurate. Such information also includes contact information for the principal. If the authorizing document being accessed is health related, such as a medical power of attorney or a living will, such information also includes any optional profile information regarding the principal. Such information also includes disclosure if any agent related to the authorizing document has resigned or otherwise ceased to continue as an agent. Such information also includes disclosure if documents have been submitted to the repository indicating that the principal or an agent related to the authorizing document is incompetent. The electronic version of the requested authorizing document will also be retrieved 211 from memory 206. The information 210 and electronic version of the authorizing document 211 will then be transmitted to the third party 212. Such transmission can be made through a manual process 213 such as faxing or mailing, or through the automated fax system 214, or through an electronic means 215 such as a display on the requesting third party's online-connected device, such as a computer screen, or email transmission.

A third party may access the repository's system to confirm a confirmation code 216 given to such third parties by an agent for purposes of authenticating the identity of such agent. The third party may request such confirmation by telephonic communication with an employee of the repository 217, through telephonic communication with an interactive voice response system 218, or through online access to the repository's system 219. Whichever means of initiation, the third party preferably gives the confirmation code that was given to the third party by the agent 220. The confirmation code given by the third party will be compared 221 to the confirmation code contained in memory 206. If the confirmation codes do not match, an error notification will be given to the requesting third party 222. If the confirmation codes do match, a confirmation notice including basic identifying information regarding the agent, such as name, address, and telephone number, will be transmitted 223. Such transmission can take many forms, including voice response 224, either through the repository's employee or the repository's interactive voice response system, or through an online response 225 such as by a display on the requesting third party's online-connected device, such as a computer screen, or by facsimile transmission.

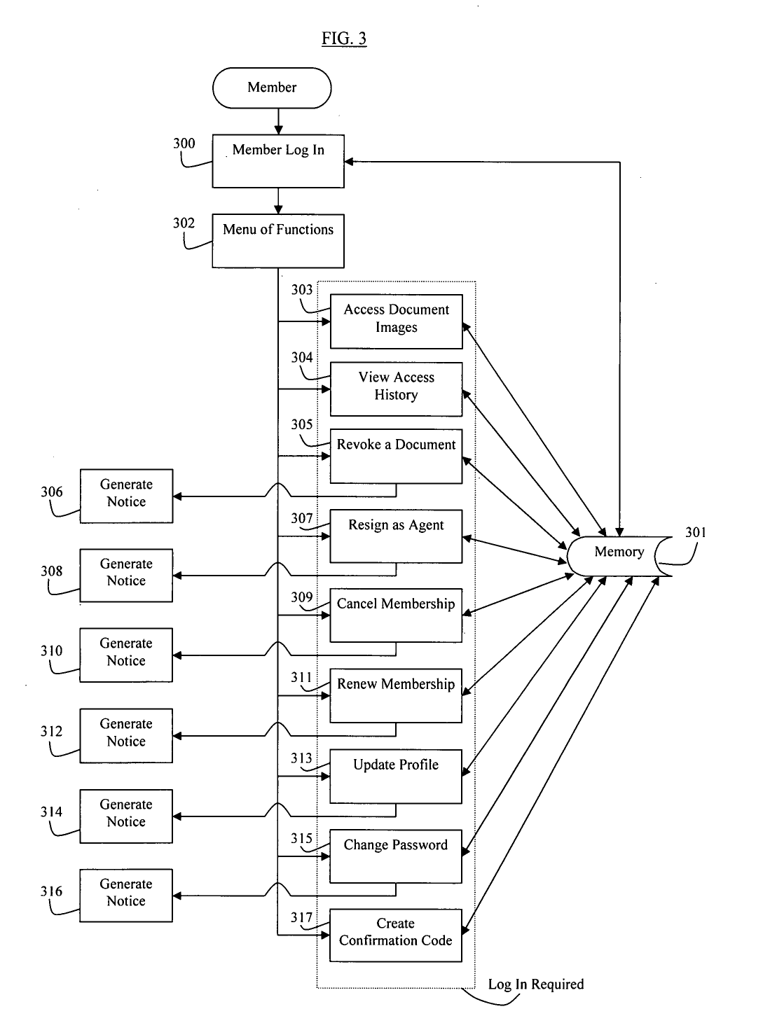

Referring to FIG. 3, members, including registered principals, agents, and monitors, may access a secured portion of the repository's system to perform the actions described below. The members input their unique access codes 300 to log into the system, which access codes are validated by the codes maintained for each member in system memory 301. Upon logging in with validated access codes, members are presented with a menu of functions 302 from which the member may choose. A logged-in member may view the electronic versions of the authorizing documents related to such member 303 stored in memory 301. The logged-in member may also view the history of third party views of the electronic versions documents related to such member 304, which history is maintained in memory 301.

A logged-in principal may process a revocation transaction related to any document related to such principal stored in the repository 305. The revocation transaction will change the status of the document in memory 301 to revoked. The revocation transaction will generate notice of the revocation 306 to the principal, agent, and monitor associated with the revoked document and to each third party whose access to the associated document is recorded in the access history maintained in memory 301. Such notice may take any suitable form including an email, fax, or mailed notice.

A logged-in agent may process a resignation transaction related to any document related to such agent stored in the repository 307. The resignation transaction will change the status of the agent record in memory 301 to resigned. The resignation transaction will generate a notice of the resignation 308 to the principal, agent, and monitor associated with the related document. Such notice may take the form of an email, fax, or mailed notice.

A logged-in principal may cancel the principal's membership in the repository 309. The cancellation transaction will change the status of the principal record in memory 301 to cancelled. The cancellation transaction will generate a notice of the cancellation 310 to the principal and any agent or monitor associated with the principal. Such notice may take the form of an email, fax, or mailed notice.

A logged-in member may renew the membership of a principal in the repository 311. Such renewal transaction will involve the processing of a credit card payment for the amount of the renewal fee. The renewal transaction will update the membership expiration date in memory 301. The renewal transaction will generate a receipt notice for the renewal payment 312 to the member who processed the renewal transaction. Such notice may take the form of an email, fax, or mailed notice.

A logged-in member may update an associated principal's profile information in the repository 313. In one embodiment of the present invention, the profile information is the optional information regarding any medical conditions or allergies and emergency contact information regarding the principal that was provided during the initial registration with the repository or by a subsequent update profile transaction. The update profile transaction modifies the profile information of the principal's record in memory 301. The update profile transaction will generate a notice to the principal and any associated agent that the profile has been updated 314. Such notice may take the form of an email, fax, or mailed notice. A logged-in member may change that member's password code 315 that is maintained in system memory 301. The change password transaction will generate a notice to the member that the password has been changed 316. Such notice may take the form of an email, fax, or mailed notice. A logged-in agent may create a confirmation code 317. The confirmation code will store a new confirmation code in memory 301.

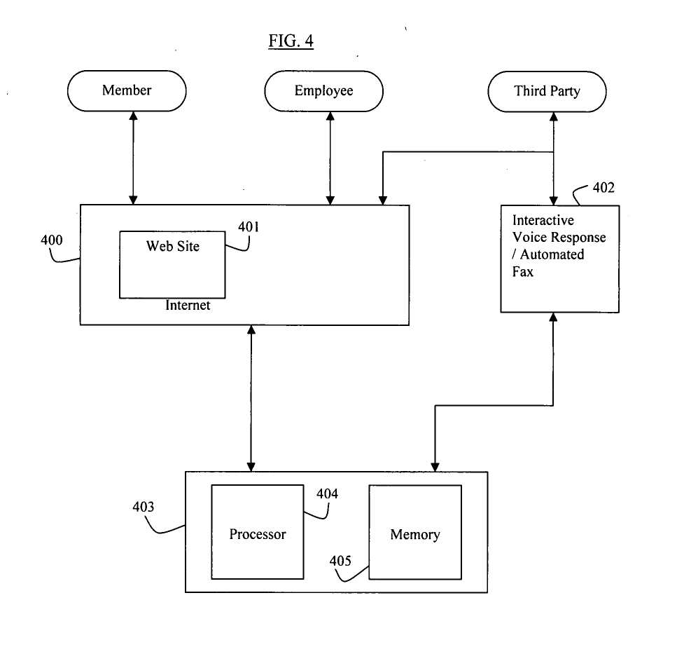

FIG. 4 illustrates major components of an embodiment of the invention. A user of the repository's system, which user may be a registered member of the repository, an employee of the repository, or a third party, may interact with the system through a network 400, which for these purposes include the internet, or through the repository's interactive voice response system 402. A user may be situated anywhere in the world, as long as such user has access to either a device capable of interacting with the network 400 or a telephone, and be able to interact with the repository's system. Under the preferred embodiment of the invention, the repository's system is available for use around-the-clock throughout each year.

Users accessing through the network 400 may connect to the network by a dedicated terminal connected to the repository's network or may connect through any device, most typically a personal computer, capable of accessing the internet. The interface for users connecting through the internet is a web site 401. The web site is viewable by users across multiple types of computer hardware and software systems equipped with browser software.

Users accessing through the repository's interactive voice response system 402 may do so utilizing any telephone. Upon establishing a connection with the interactive voice response system 402 the user will be guided through a series of prompts to enter, either by speaking or through touch tones, information needed to generate a response from the repository's system. As telephones become more like computers, the distinctions between computers and telephones may blur.

Whether interfacing through a network 400 or the interactive voice response system 402, a user interacts with the repository's application software residing on the repository's computer server 403. The computer server 403 may be one or more physical devices which may reside at the repository's offices, at remote locations, or a combination of the two. A computer server comprises a processor 404 and a memory 405 in communication with the processor. The processor 404 is a hardware device for executing software, particularly software stored in memory 405. The memory 405 may incorporate electronic, magnetic, optical, and other types of storage media. The memory devices are scalable, allowing for the addition of additional memory capacity as the need arises. The memory 405 can have a distributed architecture where various components are situated remote from one another, but can be accessed by the processor 404.

U.S. Pat. No. 5,241,466 (“the '466 patent”), issued to Perry et al. and incorporated by reference, provides additional information concerning implementation of a document repository system according to the present invention, particularly with respect to living and testamentary wills, durable powers of attorney for health care, authorizations for organ and bone marrow donation and information concerning insurance. While the '466 patent discloses a document repository, it does not disclose or suggest providing protections to principals through the monitoring and reporting of access to authorizing documents. The '466 patent does not disclose or suggest providing principals an effective means of revoking authorizing documents. The '466 patent does not disclose or suggest promoting the acceptance of authorizing documents by third parties by providing third parties key information about the source of the electronic authorizing documents stored on the repository, providing third parties with information as to whether or not the principal has confirmed that the electronic version of the authorizing documents stored on the repository are complete and accurate, notifying the third parties if the authorizing documents have been revoked or amended, notifying the third parties if an agent has resigned, and providing a mechanism for the third parties to confirm the identity of an agent. Further, the '466 patent does not provide an effective way for an agent to communicate and effect his or her resignation or withdrawal.

The embodiments of the present invention described above anticipate that authorizing documents will typically be paper documents having handwritten signatures or previously scanned documents, but electronic documents having digital signatures can be used alternatively. U.S. Pat. No. 5,214,702, issued to Fischer, is incorporated by reference as one example for incorporating digital signature technology into a document repository system according to the present invention.

It is recognized that with any computerized document repository, there is a possibility of fraud, unauthorized access to the database and the like. While it is believed that images of paper documents bearing signatures or of electronic documents bearing digital signatures is adequate security in nearly all cases, it is recognized that some users of the system may require a higher level of security concerning personal identification. In those cases where the user believes additional security is required, the identity of a user can be verified through a computer system by biometric identity analysis, such as by transmission of a digital photograph of a principal or agent or by a fingerprint or an eye scan. U.S. Pat. No. 5,214,702, issued to Nanavati et al. and incorporated by reference, discloses a method for identity verification using a central biometric authority. U.S. Pat. No. 6,073,106, issued to Rozen, et al. and incorporated by reference, describes a method for managing and controlling access to personal information using a system of personal identification numbers.

To prevent fraud, a principal may request additional security to ensure that an imposter does not access the document repository and make unauthorized filings or changes, and the measures identified above can help to ensure that only the principal can file or change documents such as a financial power of attorney. The principal may further request measures to ensure that only the principal's designated agent can serve as the principal's agent. To address these concerns, a principal can have personal biometric identification data, such as a digital fingerprint, associated with a document such as a financial power of attorney. The operator of the document repository can issue the principal a temporary pass code that the principal can give to his agent, and the agent can use the pass code to access the document repository system to register his own biometric data, such as a voice print, which can be associated with the same documents that the principal files.

For users who are concerned about computer security, it may be desirable to add additional measures for security of the documents held within the repository. Users or the system operator may wish to be able to prove without doubt when and by whom certain documents were filed or altered in the repository. Technology can be employed to record who files and accesses the documents and when. For example, U.S. Pat. No. 6,948,069, issued to Teppler and incorporated by reference, provides a method and system for determining and maintaining trust in digital image files with certifiable timestamps associated with documents.

While it is generally anticipated that a principal will furnish his or her own documents, such as a financial power of attorney, typically prepared with the help of an attorney, for storage in the document repository, the present invention contemplates providing authorizing documents to customers through a manual or online question and answer session with the customer. At the time of this writing, an internet website at http://www.partingwishes.com/ advertises that it provides wills and powers of attorney to customers using an automated online question-and-answer wizard, stores unsigned versions of the documents and provides a means for pre-designated persons to access the documents when the customer becomes incapacitated or dies. Unlike the referenced web site, the present invention is a repository for legally executed authorizing documents and provides a number of inventive concepts not addressed by the referenced web site, such as, but not limited to, monitoring, third party authentication, confirmation codes, revocation, and agent resignation.

In summary, the present invention provides a method for operating a document repository, wherein an authorizing document is executed by a principal. The operator receives the authorizing document, prepares an electronic version of the authorizing document, and stores the electronic version in the computer's memory. When the operator receives a request from a third party for a copy of the authorizing document, the operator sends a copy of the authorizing document to the third party. A notice is generated concerning the request from the third party and sent to the principal and/or to one or more agents and/or to one or more monitors. The operation may be fully automated, in which case the operator may be considered the computer system, or partially automated, where some human intervention is required. In either case, the operator may be the computer system, a human or an entity that owns and/or operates the document repository.

The present invention further includes storing, handling, managing and/or dispersing documents that are not authorizing documents, which includes documents all of types that a customer may want a repository to store and manage. For example, a customer may want a repository to store life insurance papers, or the repository may wish to offer the service of storing death certificates in a computer system that can be accessed through the internet, telephone system, manually through a human operator or by any suitable means. In a preferred embodiment, the present invention provides a method for managing documents for a customer, where the customer designates an appointee, comprising receiving a first document from the customer, storing an electronic version of the first document in memory, receiving a request from a third party for a copy of the first document, sending a copy of the first document to the third party, generating a notice concerning the request from the third party, sending the notice to the customer or to the appointee; receiving a second document concerning the customer, storing an electronic version of the second document in memory, receiving a request from a fourth party for a copy of the second document, and sending a copy of the second document to the fourth party.

The present invention provides a system for operating a document repository, wherein an authorizing document is executed by a principal. The system generally comprises a computer system integrated with external devices that can be used for receiving, converting to a selected electronic format, and sending documents, and such devices or a person provide a means for receiving the authorizing document. A device can be adapted for preparing an electronic copy of the authorizing document using readily available machines, components and software. The computer system can receive and store the electronic copy in memory, and a receiving device, such as a telephone system, a facsimile machine, a human operator inputting information into a computer or an internet connection, can be adapted for receiving a request from a third party for a copy of the authorizing document. A sending device, such as the computer system via the internet, a computerized external device that interfaces with the computer, a telephone or a facsimile machine, can be similarly adaptively integrated with the computer system for sending a copy of the authorizing document to the third party, or this can be done manually. A software system can be designed to run in the computer system and interface with the external devices, such as designing the software to generate a notice concerning the request from the third party. The sending device can also be configured to send the notice concerning the request from the third party to the principal, the agent and/or the monitor.

In summary, there are various embodiments of the present invention. The present invention provides a method for operating a document repository, wherein an authorizing document is executed by a principal, and wherein the principal identifies an agent or trustee in the document, the method including storing an electronic version of the authorizing document in memory; receiving a request from a third party for a copy of the authorizing document; sending a copy of the authorizing document to the third party; generating a notice concerning the request from the third party; and sending the notice to the principal and/or to the agent or trustee. Depository operations may include receiving a name of a monitoring person from the principal; tracking access to the authorizing document; generating a notice concerning the access to the authorizing document; sending the notice to the monitoring person, wherein the monitoring person is not the principal or the agent or the trustee. Depository operations may also include providing a confirmation code to the agent or trustee, who provides the confirmation code to the third party; receiving a request from the third party for verification that the confirmation code is valid; determining whether the confirmation code is valid; and notifying the third party whether the confirmation code is valid or invalid. Another aspect of operating a document repository is processing a resignation from the agent or trustee and then sending a notice of the resignation to the third party.

In another embodiment, the present invention provides a method for handling an authorizing document for a principal to the authorizing document, the method including receiving the authorizing document, wherein the authorizing document identifies an agent or trustee for the principal; storing an electronic version of the document in memory; receiving a notice from the principal revoking the authorizing document; and generating a notice that the principal revoked the authorizing document. This aspect of the invention includes a method for handling a financial power of attorney (referred to as “an FPOA”) for a principal to the FPOA, the method including receiving the FPOA, wherein the FPOA names an agent for the principal; making an image of the FPOA; storing the image in memory; receiving a first request for a copy of the FPOA from a third party; sending a copy of the FPOA to the third party; receiving a notice from the principal that the FPOA is revoked; receiving a second request for a copy of the FPOA from the third party or from a fourth party; and notifying the third party or the fourth party that the FPOA has been revoked.

In a method for managing a document for a customer, the customer designating an appointee, the method includes receiving the document from the customer; storing an electronic version of the document in memory; receiving a request from a third party for a copy of the document; sending a copy of the document to the third party; generating a notice concerning the request from the third party; sending the notice to the customer or to the appointee; generating a record for each access made to the document, wherein an access history is created; and sending a copy of the access history to the customer or to the appointee. Alternatively, the steps include receiving the document from the customer; storing an electronic version of the document in memory; receiving a request from a third party for a copy of the document; sending a copy of the document to the third party; generating a notice concerning the request from the third party; sending the notice to the customer; generating a record for each access made to the document, wherein an access history is created; sending a copy of the access history to the customer; receiving an instruction from the customer concerning the document; and communicating the instruction to the third party.

One alternative step in the method is receiving a confirmed verification letter from the customer confirming that the copy of the electronic version of the document is a true and accurate copy of the document received from the customer, except for the notice placed on the document. Here, an operator can manage the document for the customer, and wherein the operator operates an internet website and has contact information, the internet website having an address, and wherein the notice includes the contact information and/or the address of the internet website. The manager can receive a request from a third party for a copy of the document; send a copy of the document to the third party; and send a copy of the confirmed verification letter to the third party. The manager can communicate to the third party information about the document received from the customer. The information about the document includes, but is not limited to, whether the document was an original paper document, a paper copy of a document, an electronic image of a paper document or an electronic document.

In other words, the present invention provides a method for storing and dispersing copies of a document, the document identifying a first party and a second party, including storing an electronic version of the document in memory; receiving a request from a third party for a copy of the document; sending a copy of the document to the third party; generating a notice concerning the request from the third party; sending the notice to the first party or to an appointee of the first party; generating a record for each copy made of the document, wherein a copy history is created; storing the copy history in memory; receiving a first instruction from the first party concerning the document or receiving a second instruction from the second party concerning the document; and communicating the first instruction or the second instruction to the third party. The first party can be a principal, and the document is a financial power of attorney, a medical power of attorney, a testamentary will, or a trust. Alternatively, the first party can amend the document and create a revised document, in which case the method includes storing the revised document; generating and storing a message concerning the amendment to the document; and sending a copy of the message to the second party.

In one embodiment the method includes receiving a first document from the customer; storing an electronic version of the first document in memory; receiving a request from a third party for a copy of the first document; sending a copy of the first document to the third party; generating a notice concerning the request from the third party; sending the notice to the customer or to the appointee; receiving a second document concerning the customer; storing an electronic version of the second document in memory; receiving a request from a fourth party for a copy of the second document; and sending a copy of the second document to the fourth party. Preferably, the second document is a death certificate, while the first document is a power of attorney.

In another embodiment the present invention provides a system for operating a document repository, wherein an authorizing document is executed by a principal, and wherein the principal identifies an agent or trustee in the document, means for receiving the authorizing document; a device adapted for preparing an electronic copy of the authorizing document; a computer system adapted for receiving and storing the electronic copy in memory; a receiving device adapted for receiving a request from a third party for a copy of the authorizing document; a sending device adaptively coupled with the computer system for sending a copy of the authorizing document to the third party; and a software system operatively working in the computer system and being adapted to generate a notice concerning the request from the third party, wherein the sending device is further adapted to send the notice concerning the request from the third party to the principal and/or to a person that the principal designates.

One skilled in the art will appreciate the variety of computer hardware and related software which may operate as a computer server 403 in accordance with the present invention. Numerous electronic devices can be operatively coupled with a computer having memory and a software system operating the devices and the computer to provide the various features described as elements of the present invention. The embodiments described in the present disclosure are considered an exemplification of the principles of the invention and are not intended to limit the scope of the claimed inventive concept to the embodiments illustrated. The scope of the invention is set forth in the following claims.

1. A method for operating a document repository, wherein an authorizing document is executed by a principal, and wherein the principal identifies an agent or trustee in the document, comprising the steps of:
storing an electronic version of the authorizing document in memory;
receiving a request from a third party for a copy of the authorizing document;
sending a copy of the authorizing document to the third party;
generating a notice concerning the request from the third party; and
sending the notice to the principal and/or to the agent or trustee.

2. The method of claim 1, wherein the principal identifies a monitor for the authorizing document; further comprising sending the notice to the monitor.

3. The method of claim 1, further comprising maintaining a record for each access of the authorizing document for assembling a history of accesses; and providing the history of accesses to the principal and/or to the agent or trustee.

4. The method of claim 2, further comprising maintaining a record for each access of the authorizing document for assembling a history of accesses; and providing the history of accesses to the principal, the agent or trustee and/or to the monitor.

5. The method of claim 1, wherein the authorizing document is a financial power of attorney.

6. The method of claim 1, further comprising receiving a notice from the principal revoking the authorizing document; and generating a notice that the principal revoked the authorizing document.

7. The method of claim 1, further comprising:
receiving a name of a monitoring person from the principal;
tracking access to the authorizing document;
generating a notice concerning the access to the authorizing document;
sending the notice to the monitoring person, wherein the monitoring person is not the principal or the agent or the trustee.

8. The method of claim 1, further comprising:
providing a confirmation code to the agent or trustee, wherein the agent or trustee provides the confirmation code to a third party;
receiving a request from the third party for verification that the confirmation code is valid;
determining whether the confirmation code is valid; and
notifying the third party whether the confirmation code is valid or invalid.

9. The method of claim 1, further comprising processing a resignation from the agent or trustee.

10. A method for handling an authorizing document for a principal to the authorizing document, comprising the steps of:
receiving the authorizing document, wherein the authorizing document identifies an agent or trustee for the principal;
storing an electronic version of the document in memory;
receiving a notice from the principal revoking the authorizing document; and
generating a notice that the principal revoked the authorizing document.

11. The method of claim 10, further comprising sending the notice to the principal and/or to the agent or trustee.

12. The method of claim 11, further comprising recording access requests from persons and/or entities concerning the authorizing document; and notifying the persons and/or entities that the principal revoked the authorizing document.

13. The method of claim 10, further comprising receiving a request from a third party for a copy of the authorizing document; and sending the notice to the third party that the principal revoked the authorizing document.

14. A method for operating a repository for an authorizing document, the authorizing document being executed by a principal and identifying an agent or a trustee, comprising the steps of:
receiving the authorizing document;
making an image of the authorizing document;
storing the image in memory;
receiving a name of a monitoring person from the principal;
tracking access to the authorizing document;
generating a notice concerning the access to the authorizing document;
sending the notice to the monitoring person, wherein the monitoring person is not the principal or the agent or the trustee.

15. The method of claim 14, further comprising processing a resignation from the agent or trustee.

16. A method for operating a document repository, wherein a document is executed by a principal, and wherein the principal identifies an agent or trustee in the document, comprising the steps of:
storing a copy of the document in memory;
providing a confirmation code to the agent or trustee, wherein the agent or trustee provides the confirmation code to a third party;
receiving a request from the third party for verification that the confirmation code is valid;
determining whether the confirmation code is valid; and
notifying the third party whether the confirmation code is valid or invalid.

17. A method for providing a document repository service for storing and providing a copy of an authorizing document, the authorizing document being executed by a principal who authorizes an agent or trustee to act on behalf of the principal, comprising the steps of:
obtaining the authorizing document;
generating an electronic copy of the authorizing document;
storing the electronic copy in computer memory; and
processing a resignation from the agent or trustee.

18. The method of claim 17, further comprising receiving a request from a third party for a copy of the authorizing document; and sending a notice to the third party that the agent or trustee resigned.

19. A system for operating a document repository, wherein an authorizing document is executed by a principal, and wherein the principal identifies an agent or trustee in the document, comprising:
means for receiving the authorizing document;
a device adapted for preparing an electronic copy of the authorizing document;
a computer system adapted for receiving and storing the electronic copy in memory;
a receiving device adapted for receiving a request from a third party for a copy of the authorizing document;
a sending device adaptively coupled with the computer system for sending a copy of the authorizing document to the third party; and
a software system operatively working in the computer system and being adapted to generate a notice concerning the request from the third party, wherein the sending device is further adapted to send the notice concerning the request from the third party to the principal and/or to a person that the principal designates.

20. The system of claim 19, further comprising a user interface, wherein the computer system and the software system operatively working in the computer system are adapted to provide the user interface as an internet website, wherein the internet website can be accessed through the internet.
